(19) United States
(12) Patent Application Publication
(10) Pub. No.: US 2025/0340691 A1
(43) Pub. Date: Nov. 6, 2025

(54) BOTTLEBRUSH POLYMER NETWORK, METHOD FOR THE MANUFACTURE THEREOF, AND PRESSURE SENSITIVE ADHESIVE

(71) Applicant: University of Massachusetts, Westbourugh, MA (US)

(72) Inventors: Brandon R. Clarke, Boston, MA (US); Alfred J. Crosby, Amherst, MA (US); Gregory N. Tew, South Deerfield, MA (US)

(21) Appl. No.: 19/198,486

(22) Filed: May 5, 2025

Related U.S. Application Data
(60) Provisional application No. 63/642,920, filed on May 6, 2024.

(51) Int. Cl. C08F 299/08; C08G 77/46; C09J 7/38; C09J 183/12

(52) U.S. Cl. CPC C08F 299/08; C08G 77/46; C09J 7/387; C09J 183/12; C09J 2301/302; C09J 2301/414; C09J 2453/00; C09J 2483/00

(57) ABSTRACT

A bottlebrush polymer network is provided by ring opening metathesis copolymerization of macromonomers according to Formula (I), Formula (II), or a combination thereof and a macromonomer according to Formula (III)

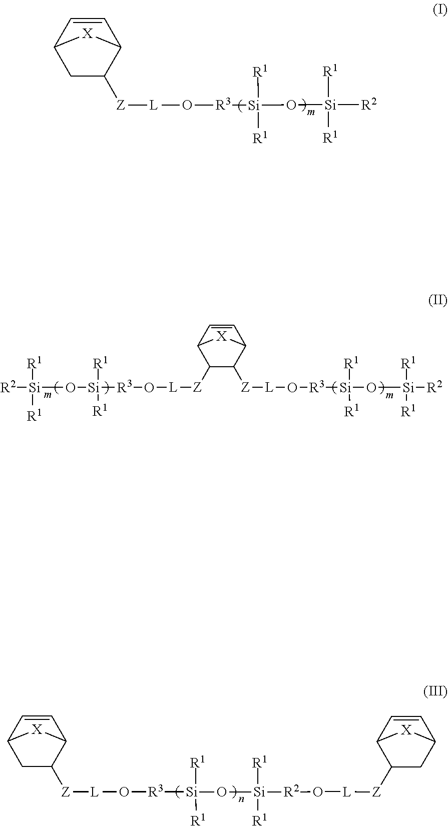

wherein X, R¹, R², R³, L, Z, m, and n are as defined herein. The bottlebrush polymer network has a degree of polymerization between crosslinks of the bottlebrush polymer network is less than two times the degree of polymerization of a primary backbone of the bottlebrush polymer network. The bottlebrush polymer network is particularly useful in pressure sensitive adhesives.

### CROSS-REFERENCE TO RELATED APPLICATION

This application claims priority to U.S. Provisional Application No. 63/642,920, filed May 6, 2024, the contents of which are hereby incorporated by reference in their entirety.

### FEDERAL RESEARCH STATEMENT

This invention was made with government support under award number W911NF2320022 awarded by the Army Research Laboratory. The government has certain rights in the invention.

### BACKGROUND

Polymeric networks with low glass transition temperature (Tg) side chains densely grafted along the backbone form the basis of an emerging class of materials known as bottlebrush elastomers (BBEs). BBEs have recently seen a surge in popularity due to their “supersoft” (e.g., 102-106 Pascal (Pa)) elastic moduli (E), allowing them to mimic a wide variety of biological materials while remaining solventless. These low E are derived from the unique architecture of BBEs, where the sterics of side chains force network strands to extend locally into rigid rods, increasing the entanglement molecular weight and lowering the overall number of entanglements (“diluting” the entanglements). Additionally, the wide variety of tunable parameters available to BBEs (e.g., side chain length, grafting density, and crosslink density) make the architecture suitable for designer applications in additive manufacturing, wearable sensors, and soft robotics.

There accordingly remains a continuing need in the art to provide improved bottlebrush elastomer materials. It would be particularly advantageous to provide bottlebrush elastomers that are well-suited for use in adhesive applications, for example as pressure sensitive adhesives.

### SUMMARY

An aspect of the present disclosure is a bottlebrush polymer network, wherein the bottlebrush polymer network is prepared by ring opening metathesis copolymerization of macromonomers according to Formula (I), Formula (II), or a combination thereof and a macromonomer according to Formula (III)

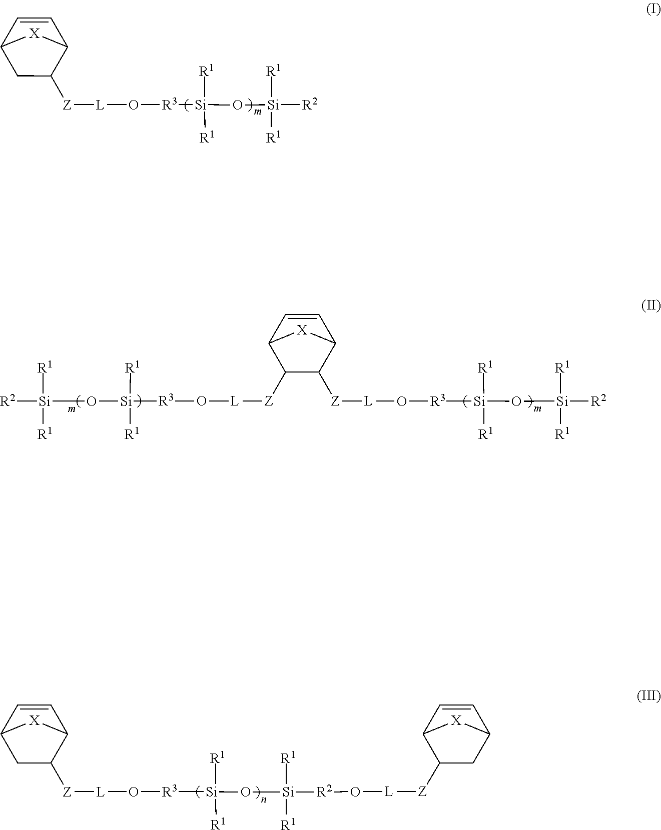

wherein in the foregoing Formulas, X is independently at each occurrence —CH₂— or —O—; R¹ is independently at each occurrence a C₁₋₆ alkyl group; R² is independently at each occurrence a C₁₋₆ alkyl group; R³ is independently at each occurrence a divalent C₁₋₁₂ alkylene group; L is independently at each occurrence a divalent C₁₋₁₂ alkylene group; Z is a single bond, an ester group, an amide group, or oxygen; m is an integer from 5 to 100; and n is an integer from 5 to 500, provided that n≥m; and wherein a degree of polymerization between crosslinks of the bottlebrush polymer network is less than two times a degree of polymerization of a primary backbone of the bottlebrush polymer network.

Another aspect is a method for the manufacture of the bottlebrush polymer network, the method comprising: polymerizing a reaction mixture comprising a macromonomer according to Formula (I), Formula (II), or a combination thereof, and a macromonomer according to Formula (III)

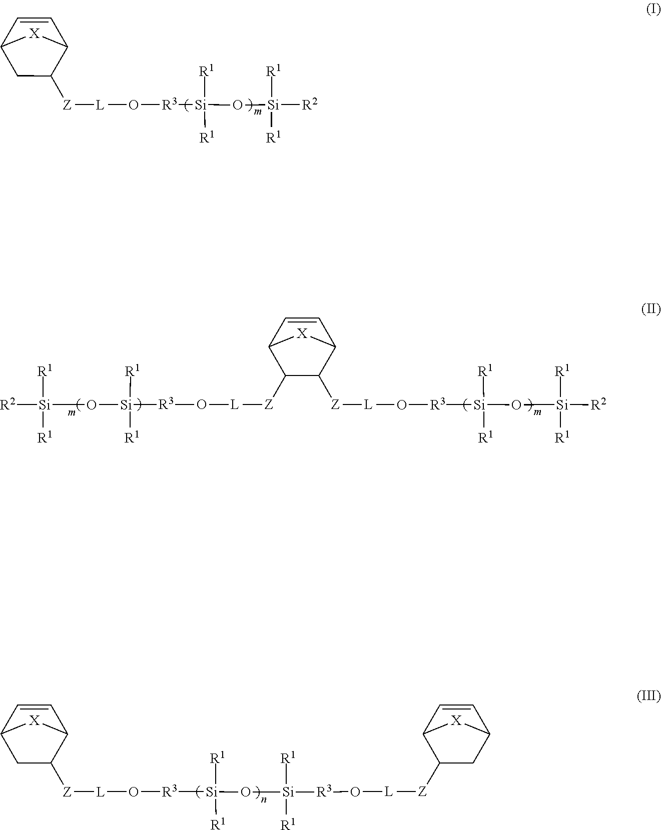

in the presence of an olefin metathesis polymerization catalyst to provide the bottlebrush polymer network; wherein in the foregoing Formulas, X is independently at each occurrence —CH₂— or —O—; R¹ is independently at each occurrence a C₁₋₆ alkyl group; R² is independently at each occurrence a C₁₋₆ alkyl group; R³ is independently at each occurrence a divalent C₁₋₁₂ alkylene group; L is independently at each occurrence a divalent C₁₋₁₂ alkylene group; Z is a single bond, an ester group, an amide group, or oxygen; m is an integer from 5 to 100; and n is an integer from 5 to 500, provided that n≥m.

Another aspect is a pressure sensitive adhesive layer comprising the bottlebrush polymer network.

Another aspect is an article comprising the pressure sensitive adhesive layer.

The above described and other features are exemplified by the following figures and detailed description.

### BRIEF DESCRIPTION OF THE DRAWINGS

The following figures are exemplary embodiments.

FIG. 1 is a schematic illustration of a bottlebrush network (BBN) highlighting the parameters nₓ (the degree of polymerization between crosslinks) and R_{K} (the kinetic chain length).

FIG. 2 shows a gel permeation chromatogram illustrating high conversion of macromonomer starting materials into ultralong bottlebrush polymers.

FIG. 3 is a plot of the elastic modulus (E) determined via indentation for a series of bottlebrush elastomers with progressively larger nₓ values.

FIG. 4 is a synthetic schematic illustrating how the polymerization of mono- and bis-norbornene functionalized poly(dimethyl siloxane) (PDMS) (Mw=1 and 9 kiloDaltons (kDa), respectively) can produce pressure sensitive adhesives (PSAs) with large viscous components due to their unique structural composition.

FIG. 5 shows a representative schematic illustrating the effects of network constitutional isomerization in high nₓ BBEs with (left) nₓ<M:I and (right) nₓ=M:I.

FIG. 6 shows a plot of Tan(δ) for high nₓ samples with nₓ=M:I (circles) and nₓ<M:I (inverted triangles), as determined via dynamic mechanical analysis (DMA). The viscous component of the nₓ=M:I NCI is considerably larger than that of the nₓ<M:I NCI.

FIG. 7 shows a plot of the storage (E′) and loss (E″) moduli for the nₓ=1000, M:I NCI.

FIG. 8 shows a plot of uniaxial tensile testing for NCIs at low crosslink density.

FIG. 9 shows a plot of Gc vs nₓ for a series of nₓ<M:I BBEs with progressively larger nₓ values (squares).

FIG. 10 shows a plot depicting the results of contact angle goniometry measurements performed on synthesized samples.

FIG. 11 is a schematic illustration of how increasing the concentration of the polymerization results in the suppression of intramolecular cyclization and the formation of stress-supporting strands.

FIG. 12 is a plot of uniaxial tensile testing for NCIs synthesized at polymerization concentrations of 0.11 molar (M), 0.22 M, and 0.45 M samples. Testing was performed at a loading rate of 10 m/sec.

FIG. 13 shows a plot of uniaxial tensile testing (left) and Tan(δ) (right) for NCIs synthesized at a polymerization concentrations of [0.11 M] using a loading rate of 10 m/sec.

FIG. 14 shows Tan(δ) profiles for NCIs synthesized at 0.11 M (circles) and 0.45 M (squares) polymerization concentrations. A 0.11 M sample synthesized at nₓ=10 (triangles) is included to emphasize the strong role that polymerization concentration plays.

FIG. 15 shows a plot of Gc values determined via PIF of PSAs synthesized at varied polymerization concentrations.

FIG. 16 illustrates how the weak tolerance of soft PSAs towards shear forces allows for easy separation of the interface when release is desired

FIG. 17 is a series of images showing that a robotic arm can lift a series of weights into a glass jar, dropping each using the shear failure mechanism, and then close the jar itself via the same mechanism.

FIG. 18 is a series of images illustrating wet-dry-wet adhesion cycling performed using the PSA.

FIG. 19 shows dielectric permittivity for various materials according to the present disclosure.

### DETAILED DESCRIPTION

Pressure sensitive adhesives (PSAs) are a class of adhesive that can easily form interfaces with substrates when pressure is applied. Bottlebrush PSAs are particularly desirable as adhesives because their architecture allows for high surface area interfaces to be formed without the time-dependent properties typically incurred from small molecule adhesives (e.g., molecular glues). The practical usefulness of previous bottlebrush PSAs is considerably limited by either weak adhesive strength, insufficient architectural control, or overly complex synthetic routes (such as atom-transfer radical polymerization).

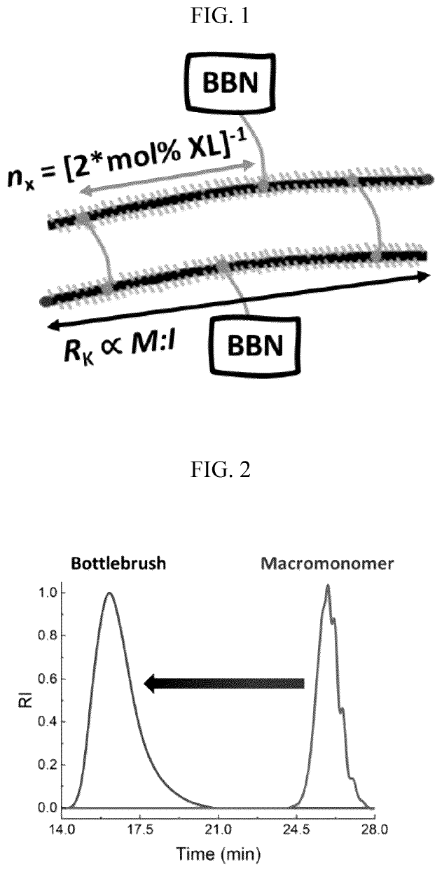

Ring-opening metathesis polymerization (ROMP) can provide synthetically simple routes to high conversion bottlebrush networks with controllable molecular architectures. In particular, it has been demonstrated that (1) ROMP BBEs have inherently higher levels of molecular defects than those generated via radical polymerization and (2) that ROMP allows for control over the relative size of defects via constitutional isomerism. These unique features of ROMP BBEs can be used to build ultra-large, fractal-like defects into samples. This primarily has been accomplished by (1) architectural control over the kinetic chain length (R_{K}) and the degree of polymerization between crosslinks (nₓ), as shown in FIG. 1; and (2) promoting loop defect formation by keeping the concentration of polymerizations low (e.g., [0.11 molar (M)]). By greatly increasing the number and size of molecular defects in samples, supersoft samples were generated which maximize contact at interfaces and dramatically increase local Van der Waals forces. Furthermore, the use of poly(dimethyl siloxane) (PDMS) side chains promotes dewetting of water on the samples, a behavior which translates to adhered interfaces and allows for underwater adhesion.

Such samples outperformed the adhesive strength of both their more tightly crosslinked and isomeric counterparts, which have considerably fewer molecular defects. These defects contribute highly to the viscous component of samples and can be directly measured with Tan(δ) experiments via dynamic mechanical analysis (DMA). The increased viscous components observed experimentally correlate strongly to increases in adhesive strength, where samples with higher magnitude Tan(δ) exhibit greater critical energy release rates (Gc), resulting in samples with Gc values about 6 times larger than commercial tape (such as VHB™1000 Tape, commercially available from 3M). The role that defects play was confirmed by increasing the concentration of the polymerization and directly observing how the increased number of stress-supporting strands reduces the viscous contribution and Gc of samples. The efficacy and reusability of the PSAs of the present disclosure was also demonstrated in a series of practical demonstrations showcasing shear induced failure mechanisms, soft robotics tasks, and underwater adhesion.

Accordingly, an aspect of the present disclosure is a bottlebrush polymer network. The bottlebrush polymer network is prepared by ring opening metathesis copolymerization of a macromonomer according to Formula (I), Formula (II), or a combination thereof and a macromonomer according to Formula (III)

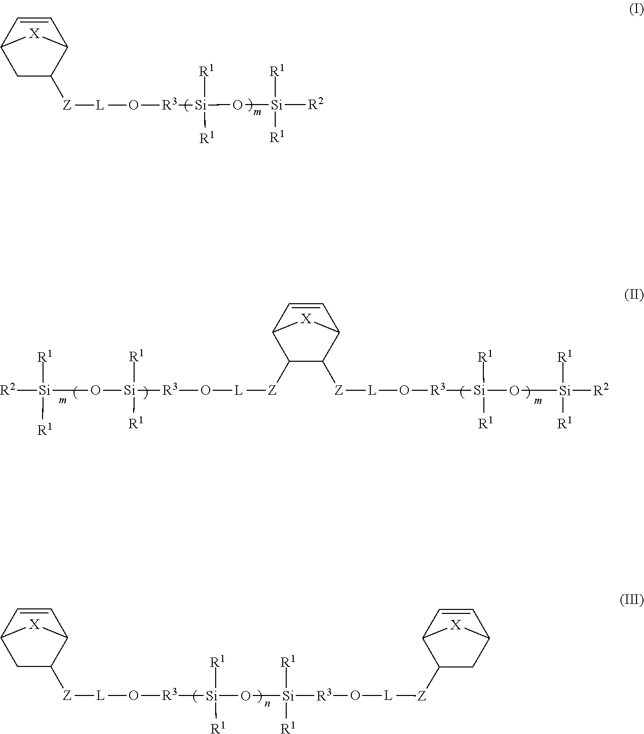

In each of Formula (I), (II), and (III), X is independently at each occurrence —CH₂— or —O—; R¹ is independently at each occurrence a C₁₋₆ alkyl group; R² is independently at each occurrence a C₁₋₆ alkyl group; R³ is independently at each occurrence a divalent C₁₋₁₂ alkylene group; L is independently at each occurrence a divalent C₁₋₁₂ alkylene group, m is an integer from 5 to 65; n is an integer from 5 to 250, and Z is a single bond, an ester group, an amide group, or oxygen (i.e., an ether group). In an aspect, each occurrence of X is —CH₂—. In an aspect, each occurrence of R¹ is a C₁₋₃ alkyl group, preferably a methyl group. In an aspect, each occurrence of R² is a butyl group. In an aspect, each occurrence of L is an ethylene group. In an aspect, each occurrence of R³ is a propylene group. In an aspect, each occurrence of Z is an ester group. In an aspect, m is an integer from 10 to 20, or 10 to 18, or 60 to 65. In an aspect, n is an integer from 5 to 75, or 75 to 225, or 100 to 200, or 100 to 150.

In an aspect, the bottlebrush polymer network is prepared by ring opening metathesis copolymerization of a macromonomer according to Formula (I), Formula (II), or a combination thereof and a macromonomer according to Formula (III) wherein each occurrence of Z is an ester group

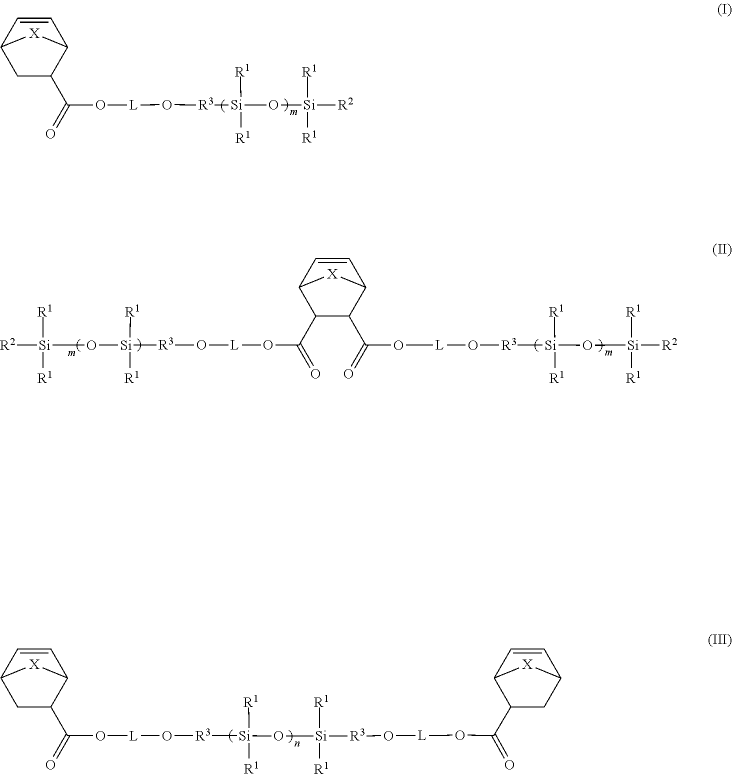

The variables X, R, L, R¹, R², R³, m, and n can be as described above.

In an aspect, the macromonomer according to Formula (I) can have the structure (IA)

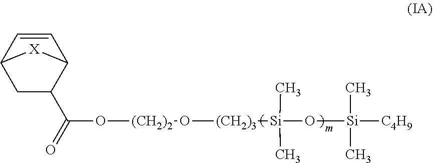

wherein m is an integer from 5 to 25, or 10 to 20, or 10 to 18, or 60 to 65. It is noted that structure (IA) includes an ester group as the “Z” component of structure (I), however any of the foregoing Z groups may be used.

In an aspect, the macromonomer according to Formula (II) can have the structure (IIA)

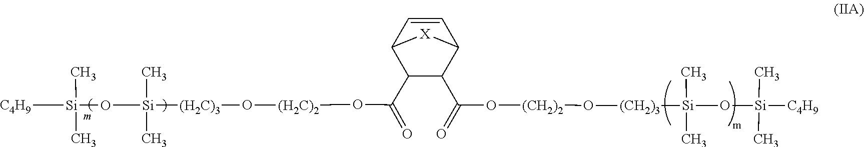

wherein m is an integer from 5 to 25, or 10 to 20, or 10 to 18, or 60 to 65. It is noted that structure (IIA) includes an ester group as the “Z” component of structure (II), however any of the foregoing Z groups may be used.

In an aspect, the macromonomer according to Formula (III) can have the structure (IIIA)

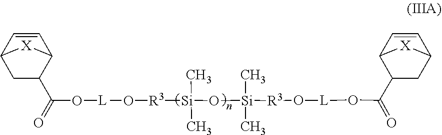

wherein L is ethylene, R³ is propylene, and n is an integer from 5 to 75, or 50 to 250, or 75 to 225, or 100 to 200, or 100 to 150. It is noted that structure (IIIA) includes an ester group as the “Z” component of structure (III), however any of the foregoing Z groups may be used.

The bottlebrush polymer network can be prepared using varying ratios of the macromonomers according to Formula (I) or (II) and (III). In an aspect, the bottlebrush polymer network can be prepared using a molar ratio of (Formula (I)+Formula (II)):Formula (III) of 1000:1 or less. For example, the molar ratio of (Formula (I)+Formula (II)):Formula (III) can be 1000:1 to 5000:1, or 1000:1 to 4000:1, or 1000:1 to 3000:1, or 1000:1 to 2000:1, or 1000:1 to 1500:1.

The bottlebrush polymer network has a degree of polymerization between crosslinks that is less than two times the degree of polymerization of a primary backbone of the bottlebrush polymer network. The degree of polymerization between crosslinks is also referred to herein as “nₓ”. The degree of polymerization of the primary backbone of the polymer network is determined by the monomer to initiator (M:I) ratio used in the preparation of the polymer network. Stated another way, the bottlebrush polymer network has a degree of polymerization between crosslinks (nₓ) that is less than two times the monomer to initiator (M:I) ratio used in the preparation of the polymer network. Preferably, the nₓ of the bottlebrush polymer network is less than or equal to the degree of polymerization of the primary backbone of the bottlebrush polymer network More preferably, the nₓ of the bottlebrush polymer network is substantially equal to the degree of polymerization of the primary backbone of the bottlebrush polymer network. When the degree of polymerization between crosslinks is more than two times the degree of polymerization of the primary backbone of the bottlebrush polymer network, the desired properties of the bottlebrush network may not be obtained, as discussed further in the working examples.

In an aspect, the degree of polymerization between crosslinks of the bottlebrush polymer network is at least 350, or at least 400, or at least 450, or at least 500, or at least 750, or at least 1000, or 350 to 4000, or 400 to 3500, or 450 to 3500, or 450 to 3000, or 350 to 2000, or 450 to 1050, and the degree of polymerization of a primary backbone of the bottlebrush polymer network is at least 350, or at least 400, or at least 450, or at least 500, or at least 750, or at least 1000, or 350 to 4000, or 400 to 3500, or 450 to 3500, or 450 to 3000, or 350 to 2000, or 450 to 1050, provided that the degree of polymerization between crosslinks of the bottlebrush polymer network and the degree of polymerization of a primary backbone of the bottlebrush polymer network differ by no more than 10%.

The bottlebrush polymer network can be characterized by gel permeation chromatography (GPC) and size exclusion chromatography multi-angle light scattering (SEC MALS).

The bottlebrush polymer primary chain can have a number average molecular weight of 1 to 8 megaDaltons (MDa). Molecular weight can be determined by GPC eluting with tetrahydrofuran relative to polystyrene standards.

The bottlebrush polymer network according to the present disclosure can provide a desirable combination of physical properties. For example, the bottlebrush polymer network can exhibit a Tan(δ) of greater than 0.5 over a frequency range of 0.1 to 100 Hertz (Hz), determined using dynamic mechanical analysis at a strain amplitude of 1%. The bottlebrush polymer network can exhibit a storage modulus of greater than 1 kPa at a frequency of 1 Hz or more, determined using dynamic mechanical analysis. The bottlebrush polymer network can exhibit a loss modulus of greater than 1 kPa at a frequency of 1 Hz or more, determined using dynamic mechanical analysis. The bottlebrush polymer network can exhibit a critical energy release rate of greater than 10 J/m². Critical energy release rate can be determined as described in the working examples below. In an aspect, the bottlebrush polymer can exhibit strain hardening behavior. Strain hardening can be tuned by tuning the composition of the bottlebrush polymer. For example, in an aspect, a bottlebrush polymer can exhibit strain hardening onset between 50 and 75% of maximum elongation. In an aspect, the bottlebrush polymer network may exhibit one or more of the foregoing properties. In an aspect, the bottlebrush polymer network can exhibit each of the foregoing properties. These and other properties, including methods of measurement, are further described in the working examples.

In a specific aspect, the bottlebrush polymer network can is derived from the macromonomer according to Formula (I) and the macromonomer according to Formula (III)

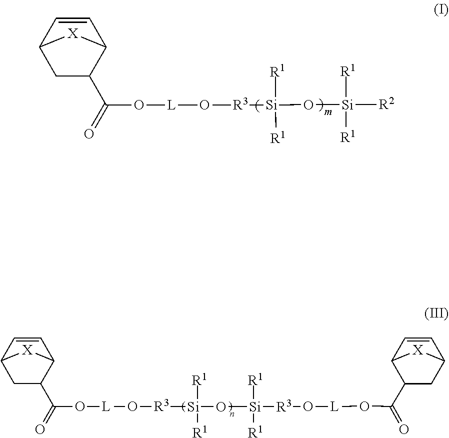

wherein each occurrence of X is —CH₂—; each occurrence of R¹ is methyl; each occurrence of R² is a butyl group; each occurrence of R³ is a propylene group; each occurrence of L is an ethylene group; m is 10 to 20; n is 100 to 150; the degree of polymerization between crosslinks of the bottlebrush polymer network is at least 350, or at least 400, or at least 450, or at least 500, or 450 to 1050; and the degree of polymerization of a primary backbone of the bottlebrush polymer network is at least 350, or at least 400, or at least 450, or at least 500, or 450 to 1050, provided that the degree of polymerization between crosslinks of the bottlebrush polymer network is less than two times the degree of polymerization of a primary backbone of the bottlebrush polymer network.

In another specific aspect, the bottlebrush polymer network can be derived from the macromonomer according to Formula (I) and the macromonomer according to Formula (III)

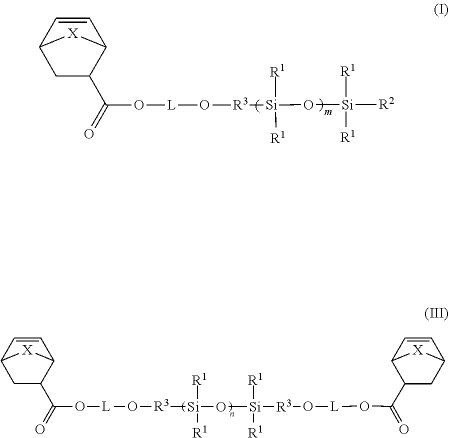

wherein each occurrence of X is —CH₂—; each occurrence of R is methyl; each occurrence of R² is a butyl group; each occurrence of R³ is a propylene group; each occurrence of L is an ethylene group; m is 10 to 20; n is 100 to 150; the degree of polymerization between crosslinks of the bottlebrush polymer network is at least 350, or at least 400, or at least 450, or at least 500, or 450 to 1050; and the degree of polymerization of a primary backbone of the bottlebrush polymer network is at least 350, or at least 400, or at least 450, or at least 500, or 450 to 1050, provided that the degree of polymerization between crosslinks of the bottlebrush polymer network is less than two times the degree of polymerization of a primary backbone of the bottlebrush polymer network. The bottlebrush polymer network exhibits: a Tan(δ) of greater than 0.5 over a frequency range of 0.1 to 100 Hz, determined using dynamic mechanical analysis; a storage modulus of greater than 1 kPa at a frequency of 1 Hz or more, determined using dynamic mechanical analysis; a loss modulus of greater than 1 kPa at a frequency of 1 Hz or more, determined using dynamic mechanical analysis; and a critical energy release rate of greater than 10 J/m².

A method for the manufacture of the bottlebrush polymer network represents another aspect of the present disclosure. The method comprises polymerizing a reaction mixture comprising a macromonomer according to Formula (I), Formula (II), or a combination thereof, and a macromonomer according to Formula (III)

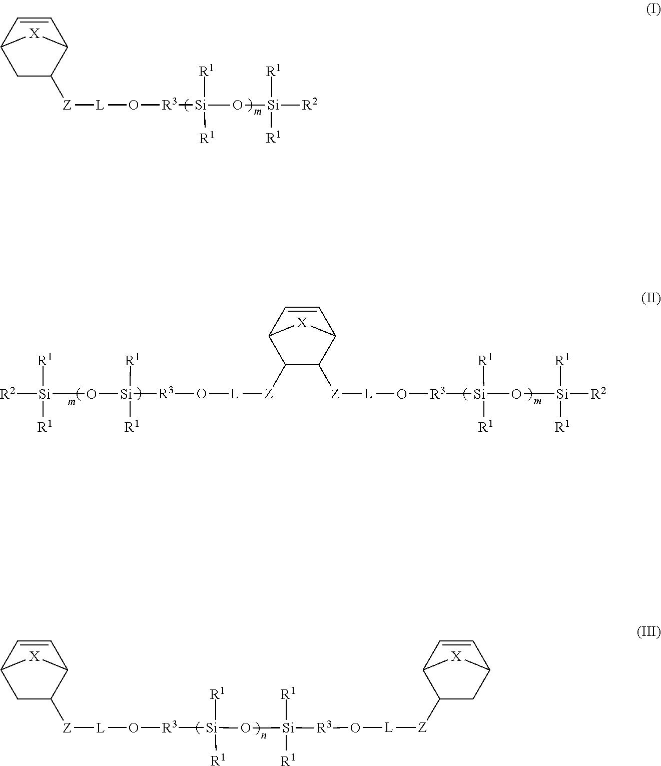

in the presence of an olefin metathesis polymerization catalyst to provide the bottlebrush polymer network; wherein X, R¹, R², R³, L, Z, m, and n can be as described above in the context of the bottlebrush polymer network. In a specific aspect, each occurrence of Z can be an ester group and the method comprises polymerizing a reaction mixture comprising a macromonomer according to Formula (I), Formula (II), or a combination thereof, and a macromonomer according to Formula (III)

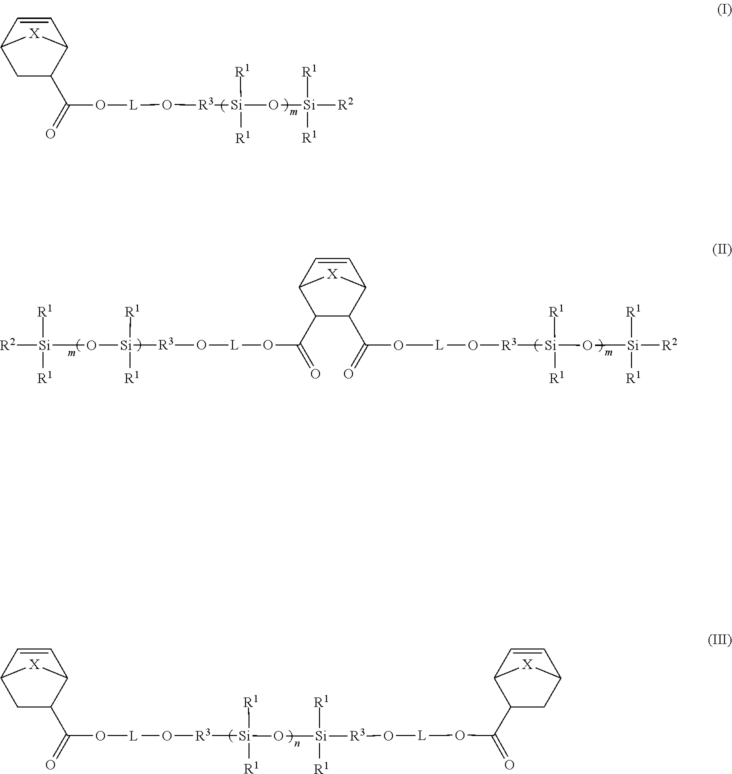

in the presence of an olefin metathesis polymerization catalyst to provide the bottlebrush polymer network; wherein X, R¹, R², R³, L, m, and n can be as described above in the context of the bottlebrush polymer network.

Polymerization conditions used to provide the bottlebrush polymer network can depend on various features, including macromonomer and catalyst identity.

Exemplary olefin metathesis catalysts can include ruthenium-containing catalysts. Exemplary catalysts include the second generation Grubbs catalysts (1,3-Bis(2,4,6-trimethylphenyl)-2-imidazolidinylidene)dichloro(phenylmethylene)(tricyclohexylphosphine) ruthenium). Such catalysts are commercially available as Grubbs Catalyst M204 from Sigma Aldrich.

Other catalysts can include those that are stimuli, photo or thermal initiated. Stated another way, catalysts which are non-reactive until exposure to a particular stimulus (e.g., heat, acid/base, or radiation, such as electromagnetic radiation (e.g., UV or visible or IR light), or ultrasound radiation, or heat-inducing radiation) can be used. Such catalysts can be referred to as “latent catalysts”, which are activatable upon exposure to the particular stimulus. In the presence of such latent catalysts, no more than 40%, or no more than 30%, or no more than 20%, or no more than 10%, or no more than 5% of the macromonomer polymerizes via ROMP to provide the polymer network in the absence of the stimulus. Latent catalysts activatable by exposure to other conditions are also contemplated.

Exemplary latent ROMP catalysts that are activated in response to heat (i.e., thermally-activatable catalysts) can include, for example, S-chelated ruthenium catalysts (such as described, for example, in Diesendruck, C. E.; Vidaysky, Y.; Ben-Asuly, A.; Lemcoff, N. G., J. Polym. Sci., Part A: Polym. Chem. 2009, 47, 4209-4213, which is incorporated by reference herein in its entirety), and N-chelated ruthenium catalysts (such as, for example, described in Szadkowska et al., Organometallics 2010, 29, 117-124, which is incorporated by reference herein in its entirety). Exemplary latent ROMP catalysts that are activated in response to radiation (also referred to as photoactivatable catalysts) can include, for example, 0-chelated and S-chelated Ruthenium catalysts; and tungsten catalysts. Suitable catalysts can be as described in U.S. Pat. No. 11,655,386, the content of which is hereby incorporated by reference in its entirety.

The conditions effective to provide the bottlebrush polymer network can comprise a time of 10 minutes to 24 hours at a temperature of 15 to 30° C.

Polymerization can be conducted in the presence of a solvent. Suitable solvents can be determined based on the solubility of the desired macromonomer structure. In an aspect, the solvent can be an organic solvent such as dichloromethane, toluene, or chloroform, and the like, or a combination thereof. In an aspect, the polymerization can be conducted in the absence of water, oxygen, or their combination.

The present inventors have also found that a particular reaction mixture concentration can be used to provide the desired polymer network structures. In an aspect, the total concentration of the macromonomer according to Formula (I) and the macromonomer according to Formula (II) in the reaction mixture can be is less than 0.4 M in the reaction mixture, preferably less than 0.25 M. For example, the concentration can be 0.08 to 0.24 M, preferably 0.09 to 0.13 M.

The polymerization can be quenched, for example, by addition of a molar excess of a vinyl ether, for example of the formula

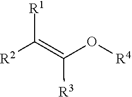

wherein each of R¹, R², R³, and R⁴ is independently a substituted or unsubstituted alkyl, a substituted or unsubstituted alkenyl, a substituted or unsubstituted alkynyl, a substituted or unsubstituted carbocyclyl, a substituted or unsubstituted phenyl, a substituted or unsubstituted heterocyclyl, or a substituted or unsubstituted heteroaryl. For example, R¹ can be an alkyl (preferably an unsubstituted alkyl), and each of R², R³, and R⁴ can be hydrogen. In an aspect, R¹ can be methyl, and each of R², R³, and R⁴ can be hydrogen. In an aspect, R¹ can be ethyl, and each of R², R³, and R⁴ can be hydrogen. In an aspect, R¹ can be propyl, and each of R², R³ and R⁴ can be hydrogen. In a specific aspect, the polymerization can be quenched by addition of a molar excess of ethyl vinyl ether. Excess ethyl vinyl ether can be removed from the bottlebrush polymer network product by vacuum.

In an aspect, the bottlebrush polymer network can be provided in a mold, and the method can further comprise removing the bottlebrush polymer network from the mold. Optionally, the bottlebrush polymer network can be rinsed to remove uncrosslinked portions.

The bottlebrush polymer network described herein can be particularly useful for adhesive applications. For example, the bottlebrush polymer network can be used as a pressure sensitive adhesive. A pressure sensitive adhesive therefore represents another aspect of the present disclosure. As used herein, the term “pressure sensitive adhesive” refers to an adhesive that possesses the following properties: (1) aggressive and permanent tack; (2) adherence with no more than finger pressure; (3) sufficient ability to hold onto an adherend; and (4) sufficient cohesive strength to be removed cleanly from the adherend.

The pressure sensitive adhesive layer comprises, or consists or, the bottlebrush polymer network described herein. Advantageously, no additional additives are necessary to provide the desired adhesivity of the present pressure sensitive adhesive. Thus the pressure sensitive adhesive can optionally exclude various additives typically used in pressure sensitive adhesives, for example including but not limited to tackifiers (e.g., rosin esters, terpenes, phenols, and aliphatic, aromatic, or mixtures of aliphatic and aromatic synthetic hydrocarbon resins), surfactants, antioxidants, plasticizers, nucleating agents, fillers (e.g., inorganic fillers and organic fillers), fibers, aging inhibitors, ultraviolet stabilizers, antistatic agents, lubricants, colorants, and combinations thereof. In an aspect, one or more of the foregoing additives may be present in the pressure sensitive adhesive layer with the proviso that the presence of the one or more additives does not significantly adversely affect the desired properties of the pressure sensitive adhesive layer. When present, such additives may be limited to 5 weight percent or less, or 1 weight percent or less, each based on the total weight of the pressure sensitive adhesive layer.

Advantageously, the present pressure sensitive adhesive layer can be reversibly adhered to a substrate, wherein upon removal from the substrate, there is no residue left behind, nor is there significant damage or deformation to the substrate or the pressure sensitive adhesive. In a further advantageous feature, the pressure sensitive adhesive layer is capable of adhering to a substrate under exceptional conditions, for example in the presence of an aqueous solution (e.g., water or salt water having a salt concentration up to 1 molar), at a reduced pressure (e.g., a pressure of at least 10⁻¹⁴ torr), at a temperature up to 120° C., or a combination of any of the foregoing conditions.

The pressure sensitive adhesive layer can generally have any shape, and can have, for example, a thickness of 100 nanometers to 5000 micrometers. Within this range, the thickness can be 500 nanometers to 5000 micrometers, or 1 to 5000 micrometers.

An article can comprise the pressure sensitive adhesive layer. For example, the pressure sensitive adhesive layer can be in contact with at least a portion of a first substrate. Optionally, the pressure sensitive adhesive layer can be in further contact with at least a portion of a second substrate on a side opposite the first substrate.

Exemplary articles can include adhesive films or tapes comprising the pressure sensitive adhesive layer, and can be designed as a single layer, double sided tape; a single sided tape in which the pressure sensitive adhesive layer is disposed on a backing layer; or a double side adhesive tape comprising two of the pressure sensitive adhesive layers, each layer being disposed on opposing sides of a carrier layer. Other arrangements are also contemplated by the present disclosure.

When present suitable carrier films or backing layers can comprise a polymeric material, for example, a polyolefin (e.g., ethylene, propylene, butylene, or hexylene), a polyurethane, a polycarbonate, and the like or a combination thereof. In some aspects, the carrier or backing layer can be made of a fabric material. The terms “fabric” or “fabric material”, as used herein, refer to a material made through weaving, knitting, braiding, intertwining, interlacing, spreading, bonding, connecting or otherwise linking. A fabric may use naturally occurring or synthetic materials or a blend or hybrid thereof wherein both natural and synthetic materials are present. A fabric may be made from a single, two or multiple components and can be made by one or more of weaving, knitting, braiding, intertwining, interlacing, spreading, bonding, connecting or linking. Exemplary synthetic materials useful for fabrics include polyester, polyolefin, spandex, nylon, carbon fiber, polyaramid, carbon fiber polyaramid hybrid, carbon fiber basalt hybrid, fiberglass, carbon fiber, metal fiber, or fiberglass hybrid. Exemplary natural fabrics include cotton, hemp, wool, silk, bamboo string, cellulose, jute, and pina. In an aspect, the material of the fabric backing layer may include any suitable material, such as nylon, carbon fiber, cotton, polyaramid, carbon fiber, polyaramid hybrid, another appropriate material, or combinations thereof.

The substrate can be permanently or temporarily attached to the pressure sensitive adhesive layer. For example, a release liner may be temporarily attached to the pressure sensitive adhesive layer and removed prior to attachment of the pressure sensitive adhesive layer to another substrate.

The first or second substrate of the article can have a variety of functions, for example providing flexibility, rigidity, strength or support, reflectivity, anti-reflectivity, polarization, or transmissivity (e.g., selective with respect to different wavelengths). That is, the substrate can be flexible or rigid; reflective or non-reflective; visibly clear, colored but transmissive, or opaque (e.g., not transmissive); and polarizing or non-polarizing.

The pressure sensitive adhesive layers described herein can be useful in bonding a range of suitable surfaces, including, for example, glass, metal, wood, plastic, paper, cardboard, or concrete.

In some aspects the pressure sensitive adhesive layers described herein can have low dielectric permittivity (F), for example less than or equal to 20, or greater than 1 to 20, or 5 to 20. In some aspects the pressure sensitive adhesive layers described herein can have a dielectric permittivity of less than 4 (e.g., greater than 1 to less than 4). The materials described herein can therefore be useful as dielectric elastomeric adhesives.

This disclosure is further illustrated by the following examples, which are non-limiting.

### EXAMPLES

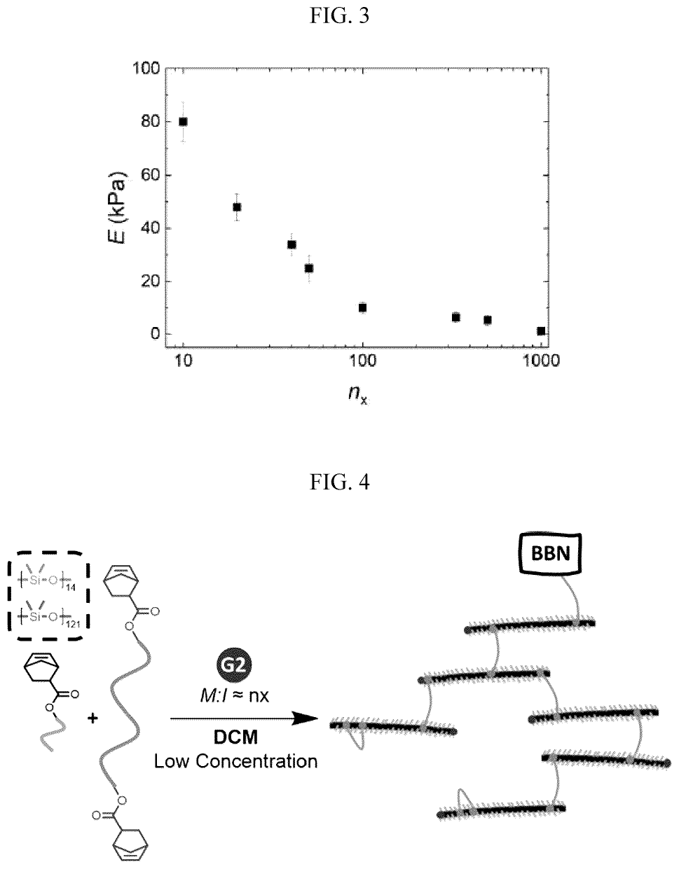

All BBEs in the present examples were synthesized via ring-opening metathesis polymerization (ROMP) of mono- and bis-norbornene functionalized poly(dimethyl siloxane), (PDMS). The use of bis-norbornene PDMS allows for in situ crosslinking to occur during the polymerization, producing insoluble networks rather than soluble bottlebrush polymers. All polymerizations herein were performed under near ambient conditions on the benchtop, owing to the extreme tolerance of Grubbs 2nd Generation catalyst (dried solvent was still used). The networks retained the desirable features BBEs including high conversion of macromonomer into large molecular weight strands (FIG. 2) and “super-soft” elastic moduli (E) (FIG. 3). FIG. 2 shows that ultralong bottlebrush polymers (degree of polymerization (DP)=1840, number average molecular weight (Mn)=2.02 MDa) were obtained. The absolute molecular weight of these bottlebrush polymers was determined via multi-angle light scattering and converted to Mn via the dispersity value found via gel permeation chromatography (GPC) (Mn=Mw(Ð)⁻¹). This polymerization serves as a control for the length of the backbones polymerized in BBEs with equivalent M:I=1000. The right side of the macromonomer GPC chromatogram is distorted because it occurs outside the lower bounds of our calibration standards. As shown in FIG. 3, the large range of elastic modulus (E) available to these samples (E∈[0.5,88] kPa) illustrates the significance of the large kinetic chain lengths (R_{K}) available via living polymerization methods such as ROMP. The present approach offers a more accessible route to supersoft BBEs than radical polymerization methods, where extreme care must be taken to synthesize analogous samples with high gel fractions. The gel fractions of the present BBEs were greater than 90%.

ROMP is further distinguished from radical polymerization methods by its ease of access to network architectures with large amounts of structural defects. BBEs with numerous, larger defects were expected to maximize surface areas at interfaces by flowing into the cracks and crevices of substrates. The dramatically increased local Van der Waals forces at the interface would cause such materials to behave as strong, reversible pressure-sensitive adhesives (PSAs) due to their “fluid-like” dangling defects.

The number of defects in the present systems are maximized by purposely building large dangling defects into synthesized networks, as shown in FIG. 4. This is accomplished primarily by (1) keeping the polymerization concentration low—which maximizes the formation of loop defects—and (2) by keeping the degree of polymerization between crosslinks approximately equal to the degree of polymerization of the primary network backbone (nₓ≈M:I). The latter point serves to introduce fractal-like dangling ends into the network, dramatically increasing the adhesive strength at the interface. Furthermore, the use of PDMS side chains endowed the present PSAs with the ability to perform underwater adhesion, owing to their dewetting behavior displacing water at interfaces.

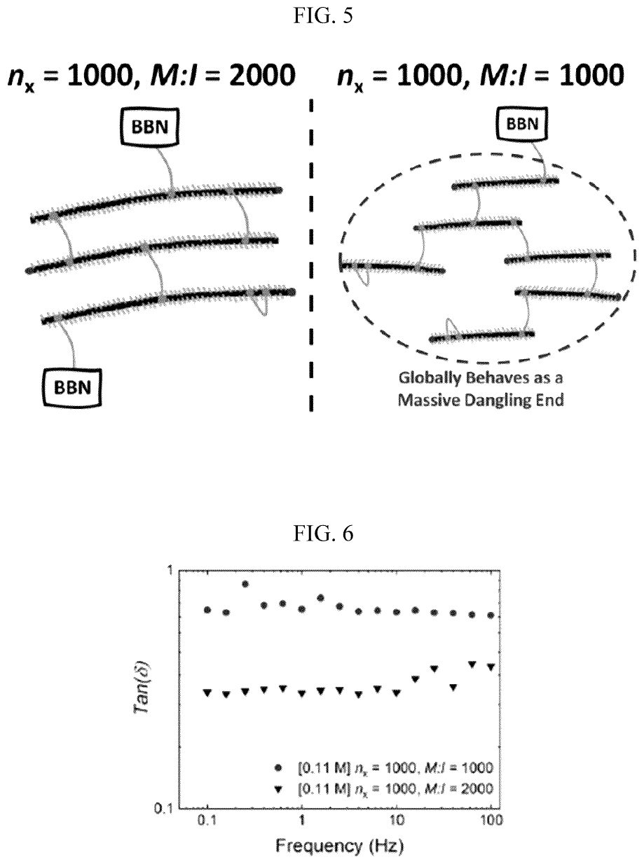

While networks with low nₓ relative to backbone M:I form multiple stress-supporting strands per backbone chain, networks designed to have nₓ=M:I will contain a population of backbones with only 1-2 crosslinks per backbone chain. This population of backbones results in large portions of the network not being interconnected, with any non-interconnected structures behaving as massive dangling defects, as shown in FIG. 5. In these PSAs, the distribution of macromonomers and crosslinkers are different from those with nₓ<M:I, but their chemical compositions remain identical (equal amounts of material being used), making them network constitutional isomers (NCIs) of each other. The dangling fractals present in the PSAs are essentially viscous liquids which are forced to behave as solids due to covalent constraints, which is predicted to contribute significantly to the viscous component of networks.

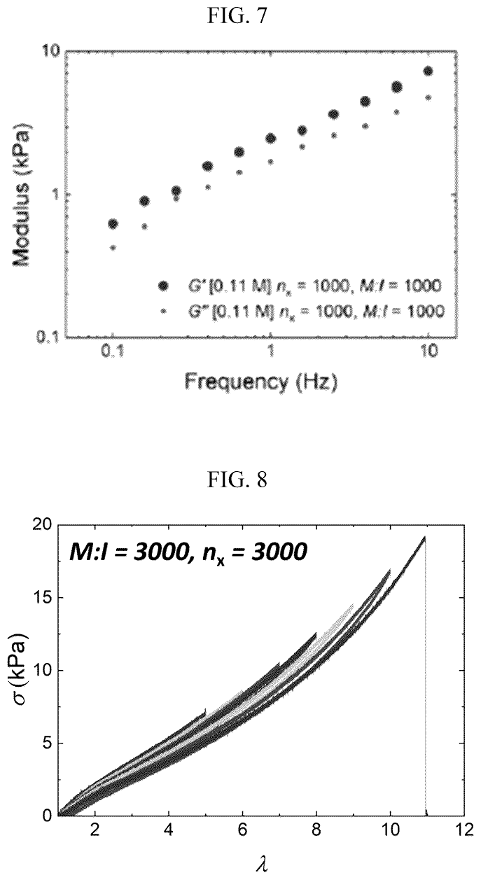

To examine this hypothesis, an nₓ=1000 NCI pair with M:I=1000 and 2000 were synthesized and tested via dynamic mechanical analysis (DMA) and uniaxial tensile testing to directly measure increases in the viscous components of samples' Tan(δ) and observe any changes in sample E, respectively. NCIs with nₓ=M:I exhibited Tan(δ) values considerably higher than NCIs with nₓ<M:I (FIG. 6), with storage (E′) and loss modulus (E″) profiles similar to those of gels near the criticality point (FIG. 7)—where the network is only just interconnected enough to be one continuous molecule. The increased viscous contributions observed via DMA experiments should indicate the potential for stronger PSAs.

As shown in FIG. 8, samples with lower crosslink densities (nₓ=M:I=3000) were also synthesized and exhibited low hysteresis and improved elongation at break. These lower crosslink density materials are expected to have similarly improved adhesion and tensile elongation as the higher crosslink density counterparts further discussed herein.

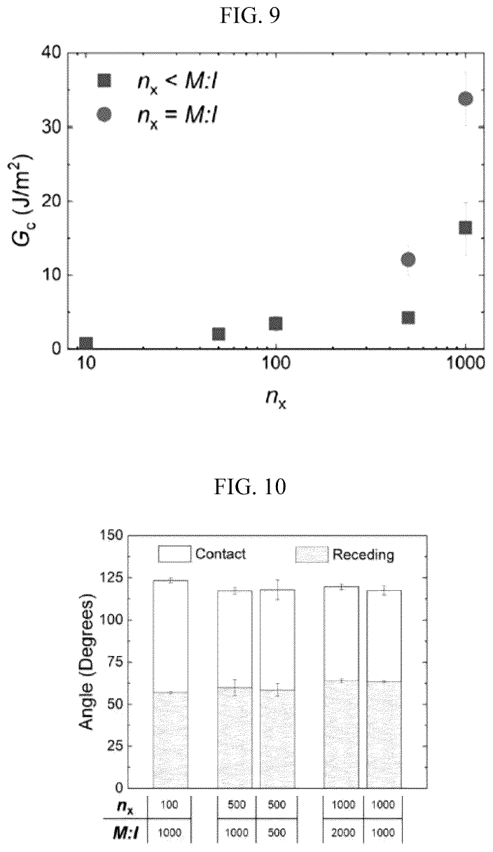

To characterize the adhesive strength of the PSAs, the recently established pressurized interfacial failure (PIF) technique was used. In PIF, an interface is formed between an annular probe and the flat surface of a sample before being separated by pushing pressurized air through the probe. The pressure required to separate the interface is then correlated to the critical energy release rate (Gc) using established geometric equations. The Gc of BBEs not produced according to the present disclosure scale inversely with E up to 16.37 J/m² (for nₓ=1000 with E=1.16±0.6 kPa), as expected for PSAs (as shown in FIG. 9). These increases in Gc are derived from increasingly greater contact at the interface as the samples become more deformable (as E decreases).

Samples with lower kinetic chain lengths were then synthesized such that nₓ approaches M:I, introducing to the architecture the dangling defects discussed prior. PIF was then performed on NCI pairs synthesized with nₓ=M:I (circles, FIG. 9), revealing that the Gc of NCIs according to the present disclosure were twice as large as those without. Importantly, increasing the M:I of samples while maintaining nₓ=M:I resulted in larger dangling ends and dramatically increased Gc (circles at nₓ=500 to circles at nₓ=1000). This directly relates the increased size of the dangling defects to observed increases in Gc, with the nₓ=1000, M:I=1000 NCI having Gc=33.8±3.7 J/m². For reference, commercial VHB1000 tape sold by 3M has a Gc value of ≈6 J/m² (as determined via PIF). Importantly, because these samples retain the same base architecture (e.g., that of PDMS bottlebrushes), the contact and receding angles of networks during water-wetting experiments remains similar across all compositions regardless of nₓ or isomerization, as shown in FIG. 10. Furthermore, the >90° contact angles (white bars, ≈120°) and <90° receding angles (shaded bars, ≈63°) reveal that water-wetting behaviors are thermodynamically unfavorable in these BBEs. This indicates that when the present PSAs adhere to water-wetted substrates, they should displace water at the interface as pressure is applied.

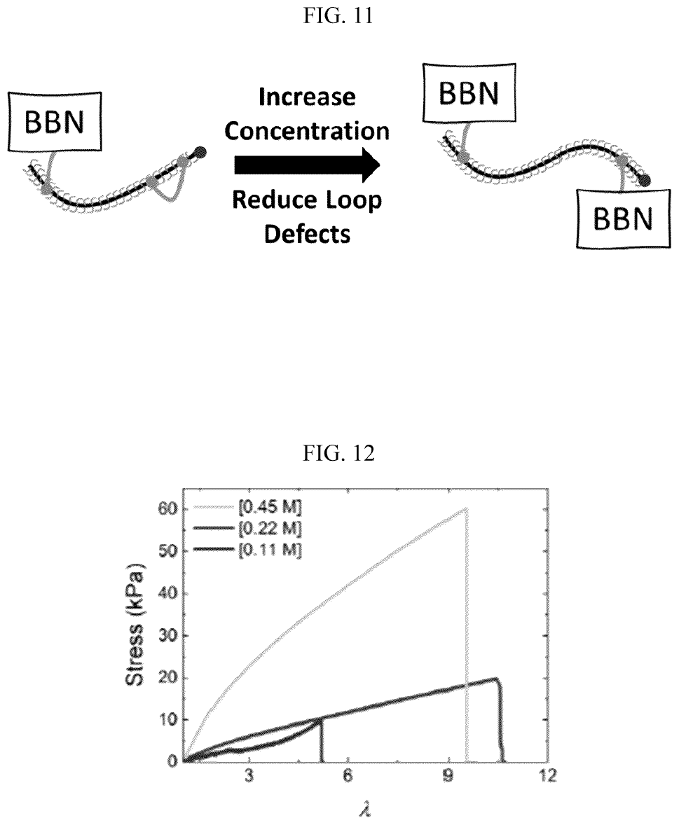

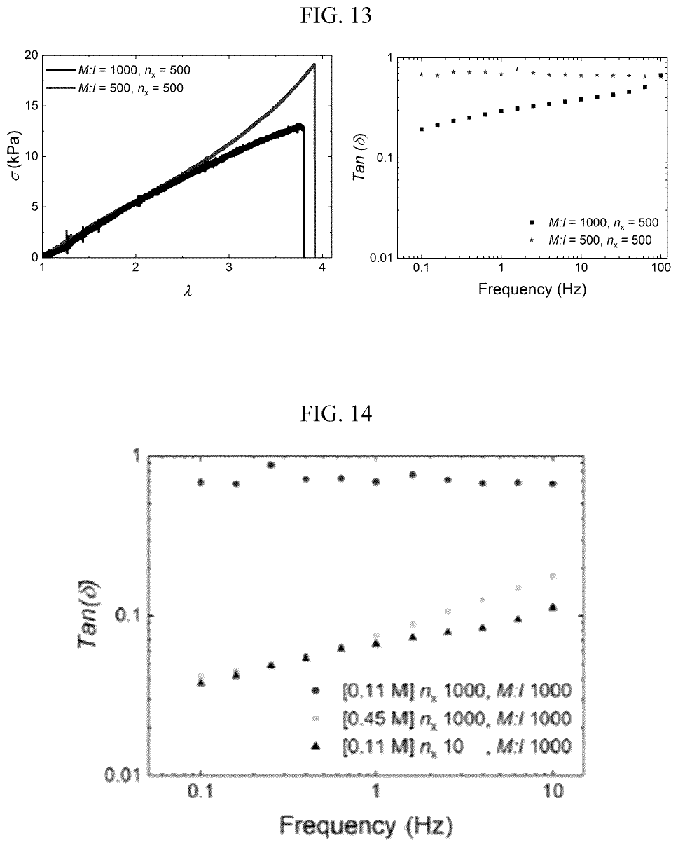

The concentration of polymerizations was found to play an important role through encouraging the formation of intramolecular loop defects. This dependency was confirmed by increasing the concentration of the polymerization and monitoring the level of defects in synthesized samples. By concentrating the polymerization, more stress-supporting strands should be formed by suppressing intramolecular cross-linking, as shown in FIG. 11. The increased number of stress-supporting strands can be directly observed via tensile testing of samples, as shown in FIG. 12. Increasing the concentration by double (from 0.11 M to 0.22 M) dramatically improves sample elongation (λ) and approximately doubles sample E. Doubling the polymerization concentration once more (to 0.45 M) results in no further increases to λ, but a significant increase in E due to suppression of loop defects. Incidentally, these higher concentration polymerizations result in BBEs with higher extensions-at-breaks than ever previously reported to date (the previous theoretical limit was given as λₘₐₓ=5). Further support of the effects of concentration is shown in FIG. 13. FIG. 13 shows that BBEs synthesized at the same concentration (e.g., [0.11 M] in this example) provided materials with similar E and elongation at break, but having differing loss tangents.

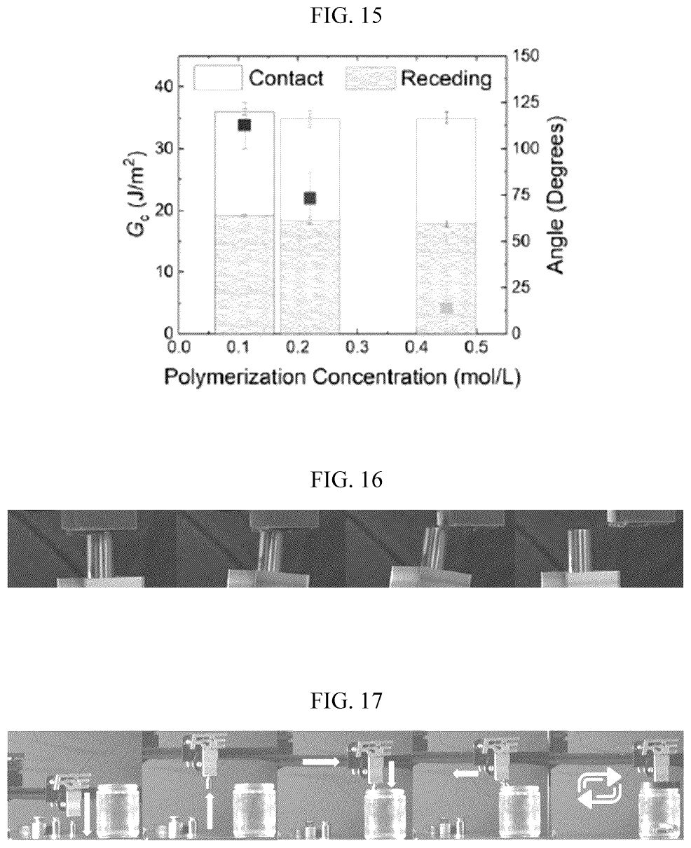

This reduction of defects also translates to associated decreases in Tan(δ) values through reductions in the viscous components of networks (FIG. 14). For example, increasing the concentration of the polymerization from 0.11 M to 0.45 M results in more than a 10-fold decrease in low frequency Tan(δ). This effect is so pronounced that the Tan(δ) of the 0.45 M samples is nearly identical to the Tan(δ) of samples synthesized with 100 times the crosslinker content (nₓ=10) at 0.11 M. These variations in Tan(δ) translate directly to observed changes in the Gc values as examined via PIF (FIG. 15). Specifically, increasing the concentration of the polymerization from 0.11 M to 0.45 M resulted in a near 8-fold decrease in Gc. Note again that there are no differences in the contact angle measurements performed at these various concentrations (FIG. 15), despite the large disparities in observed mechanical properties.

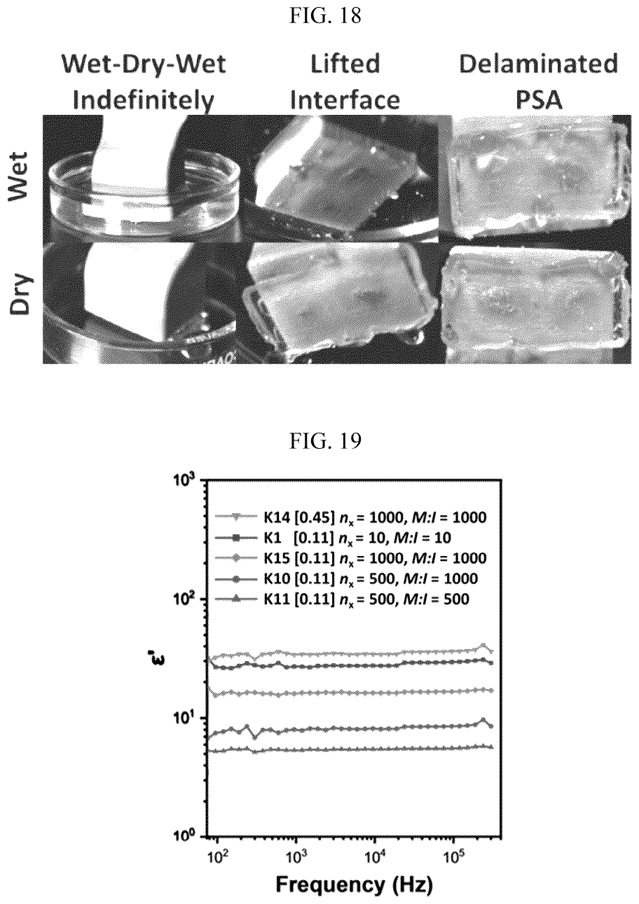

Using the knowledge gleaned from this study, a series of PSAs were synthesized for use in soft robotics and underwater adhesion. Shear induced failure to drop adhered items was used, as shown in FIG. 16. A 3D printer arm was then programmed to perform a series of demonstrations using the PSAs as the attached adhesive, the most complex of which is having the arm lift a series of weights into a glass jar before closing it with a phenol-resin lid (FIG. 17). While the [0.22 M] and [0.11 M]nₓ=1000, M:I=1000 PSAs can perform all these functions, both the [0.45 M] samples and commercial double-sided tape fail to perform them. The PSAs were additionally used for a series of wet-dry-wet adhesion tests, where the sample was pressed into a glass petri dish full of water before lifting the dish. Samples were then delaminated and pressed into dry petri dishes before lifting once more (FIG. 18). This cycle of wet-dry adhesion can be performed indefinitely if the dry petri dish does not contain any water, never damaging or deforming the sample. If the PSAs are adequately stored (cool, dark places), they can be used for all the illustrated demonstrations even four months later.

Dielectric permittivity of various samples was also tested using dielectric spectroscopy, as shown in FIG. 19. All of the materials tested exhibited low dielectric permittivity, suggesting the materials described here as strong candidates for dielectric elastomeric materials. In particular, testing via dielectric spectroscopy revealed that differences in network connectivity further result in changes in the dielectric permittivity (ε′) of synthesized samples. Interestingly, the values determined for the stiffest samples (the concentrated 1000, 1000 sample and 10, 10 sample) were the highest (e.g., ε′≈20). This value is significantly higher than known non-bottlebrush dielectric elastomeric actuators, for example having ε′≈3, and is in line with work illustrating that BBEs require less voltage to actuate than other DEAs (3.5 kV).

The present inventors have therefore provided bottlebrush PSAs with dramatically improved, controllable Gc. This was accomplished by (1) introduction of large dangling ends to BBEs via constitutional isomerization, (2) increasing the size of those dangling defects, and finally (3) through the suppression of intramolecular defects due to increased polymerization concentrations. It was further demonstrated that the water wetting/dewetting properties of the PSAs (1) are independent of crosslink density/isomerization/concentration and (2) strongly promote dewetting at interfaces. A significant improvement is therefore provided by the present disclosure.

Experimental details follow.

Synthesis of monofunctional PDMS. Norbornene-functionalized PDMS was synthesized via the Mitsunobu coupling reaction. Mono-butyl PDMS (5.944 g, 5.40 mmols, Gelest) was placed in a dry round bottom flask with a stir bar and dried overnight in a vacuum oven. The dried PDMS was dissolved in 30 mL of dried THF and placed under N₂ before adding exo-5-norbornene-2-carboxylic acid (1.490 g, 10.78 mmols, Sigma) and TPP (2.835 g, 10.81 mmols, Alfa Aesar) to the reaction mixture. The stirring reaction mixture was chilled in ice water for fifteen minutes before adding DIAD (2.120 mL, 10.77 mmols, Alfa Aesar) dropwise. The reaction was allowed to run 24 hours before being concentrated, doused in hexanes, and refrigerated at −8° C. to precipitate triphenylphospine oxide (TPPO). The TPPO was removed using gravity filtration and the resulting mixture was washed four times with methanol. The resulting mixture was concentrated and dried in a vacuum oven to remove excess hexanes. Product was a clear liquid obtained at a yield of 86%. ¹H-NMR (500 MHz, CDCl3, δ): 6.09-5.99 (m, 2H), 4.21-4.10 (m, 4H), 3.60-3.50 (T, 2H), 3.40-3.32 (T, 2H), 3.00-2.95 (s, 1H), 2.91-2.82 (s, 1H), 2.23-2.15 (q, 1H), 1.90-1.80 (m, 1H), 1.60-1.44 (m, 4H), 1.35-1.15 (m, 7H), 0.03-(−)0.02 (m, 93.22H).

Synthesis of difunctional PDMS. Norbornene-di-functionalized PDMS was synthesized via the Mitsunobu reaction in a manner identical to the mono-functional PDMS. To dried PDMS diol (5.023 g, 0.50 mmols, Gelest), exo-5-norbornene-2-carboxylic acid (0.278 g, 2.01 mmols, Sigma) and TPP (0.528 g, 2.01 mmols, Alfa Aesar) were added under N2. DIAD (0.396 mL, 2.02 mmols, Alfa Aesar) was added dropwise to the reaction. Product was a clear, viscous liquid obtained at a yield of 82%. ¹H-NMR (500 MHz, CDCl3, δ): 6.19-6.09 (m, 4H), 4.25-4.10 (t, 4H), 3.60-3.50 (T, 4H), 3.40-3.34 (T, 4H), 3.00-2.95 (s, 2H), 2.91-2.82 (s, 2H), 2.23-2.15 (q, 2H), 1.90-1.80 (m, 2H), 1.60-1.44 (m, 12H), 1.35-1.15 (m, 4H), 0.15-(−)0.15 (m, 985.02H).

ROMP Bottlebrush Network Synthesis. ROMP BBNs were synthesized by polymerizing norbornene functionalized macromonomers (250 mg) with varied amounts of crosslinker. BBNs were all polymerized using either Grubbs' second-generation catalyst (Sigma) at varied M:Is. For a typical reaction, the macromonomer and crosslinker were first dissolved in 1 mL of dried dichloromethane (DCM) in a 20 mL vial before adding 1 mL of catalyst/DCM solution. The reaction was allowed to run overnight before being quenched with 3 drops of ethyl vinyl ether (EVE, Sigma).

ROMP Bottlebrush Polymer Synthesis. Bottlebrush polymerizations were performed in round-bottom flasks containing 20 mL of dried DCM with 125 mg of macromonomer and no crosslinker added to the reaction. The synthesized bottlebrush polymers were characterized by size exclusion chromatography multi-angle light scattering (SEC MALS) and gel permeation chromatography (GPC).

Nuclear Magnetic Resonance (¹H-NMR). ¹H-NMR was used to determine the successful synthesis of macromonomer materials. NMR spectroscopy was performed using a Bruker Advance 500 MHz NMR spectrometer with CDCl₃ as a solvent (when needed).

Gel Permeation Chromatography (GPC). GPC was performed using an Agilent Technologies 1260 Infinity series system with two 5 μm mixed-D columns, a 5 μm guard column, a PL Gel 5 μm analytical Mixed-D column, and a RI detector (HP1047A); dried tetrahydrofuran (THF) was used as the eluent with a flow rate of 1.0 mL/min; polystyrene standards were used for the calibration. The dispersities (Ð) and molecular weights (Mw) of each macromonomer, crosslinker, and bottlebrush were measured using THF-GPC.

### Size Exclusion Chromatography Multi-Angle Light Scattering (SEC MALS).

MALS was performed in THF+1 vol % triethylamine (TEA) using two Polymer Laboratories 10 μm mixed-B LS columns connected in series with a Wyatt Technologies DAWN EOS MALLS detector and RI detector at a flow rate of 1.0 mL/min. MALS was used to determine the Mw of synthesized bottlebrushes, with an eluent of THF and 1% TEA.

Indentation and Tensile Testing with a Texture Analyzer. Force/displacement data were collected using a TA.XT Plus Texture Analyzer from Texture Technologies. Networks were indented with a 2 mm diameter probe at a loading rate of 0.01 mm/sec to a force of 20 mN, whereupon the probe retracted at an unloading rate of 0.01 mm/sec. The probe was cleaned with acetone between runs. Force/displacement data was analyzed using eq 1:

$$E = \frac{a}{8 α} \frac{Δ P}{Δ S} {\{ 1 + 1.33 \frac{a}{h} + 1.33 {( \frac{a}{h} )}^{3} \}}^{- 1} \qquad ( 1 )$$

where E is the elastic modulus, P is the load applied, α is the radius of the indentation probe, δ is the displacement of the probe, and h is the thickness of the sample. A Poisson's ratio of 0.5 is assumed for these calculations. Tensile testing was performed using tension clamps at a rate of 0.01 mm/sec until tensile failure.

Dynamic Mechanical Analysis (DMA). Networks were cut into 8 mm circles with a circular punch and placed within the compression clamps of a Discovery DMA 850 from TA Instruments. Samples were tested at room temperature, sweeping a frequency range of 0.1-10 Hz at a strain amplitude of 1% with a preload force of 0.1 N. The sample stage was cleaned with isopropyl alcohol between samples.

Pressurized Interfacial Failure (PIF). The pressurized interfacial failure (PIF) tests were run on a customized instrument to characterize each sample's (500 μm) critical energy release rate (Gc). The annular probe was made of borosilicate glass supplied by Hilgenberg GmbH, Germany featuring an outer radius of 1 mm and an inner pore radius of 0.1 mm. An actuator (Burleigh Inchworm, Exfo) was utilized to control the probe displacement, and the cantilever-based load cell measured the contact force. The pressure was increased by a syringe pump (Chemyx Fusion 6000) equipped with a metal syringe (20 mL, Harvard Apparatus) and measured by a pressure-sensor (PX409-100GUSBH, Omega). In a typical test, the probe was brought into contact with the sample at 10 m/s until the target load, 50 mN, was attained. Subsequently, the pressure in the system was elevated by 100 mL/min to separate the sample/probe interface. The peak load and pressure were recorded and used to calculate Gc.

Contact Angle Goniometry. Contact angle (CA) measurements with ultrapure water (Thermo Scientific MicroPure UV/UF, 18.2 QM cm) were conducted with a Biolin Scientific Attension Theta Optical Tensiometer, fitted with a C301 motorized up/down movement, a C201 automatic single liquid dispenser, a Hamilton 1001 LT 1.0 mL syringe, and Hamilton 30 gauge blunt-tipped needle. One Attention software was used to analyze video capture (6.9 FPS) of water drops automatically dispensed at a rate of 0.5 μL/s to a maximum volume of 10 μL and determine the CA. Measurements were collected at ambient temperature and humidity. Advancing (ACA or CA) and receding contact angle (RCA) were determined by statistical analysis (R 4.3.2, the tidyverse package). Reported ACA and RCA values were determined by averaging five water drops per sample.

This disclosure further encompasses the following aspects, which are non-limiting.

Aspect 1: A bottlebrush polymer network, wherein the bottlebrush polymer network is prepared by ring opening metathesis copolymerization of macromonomers according to Formula (I), Formula (II), or a combination thereof and a macromonomer according to Formula (III)

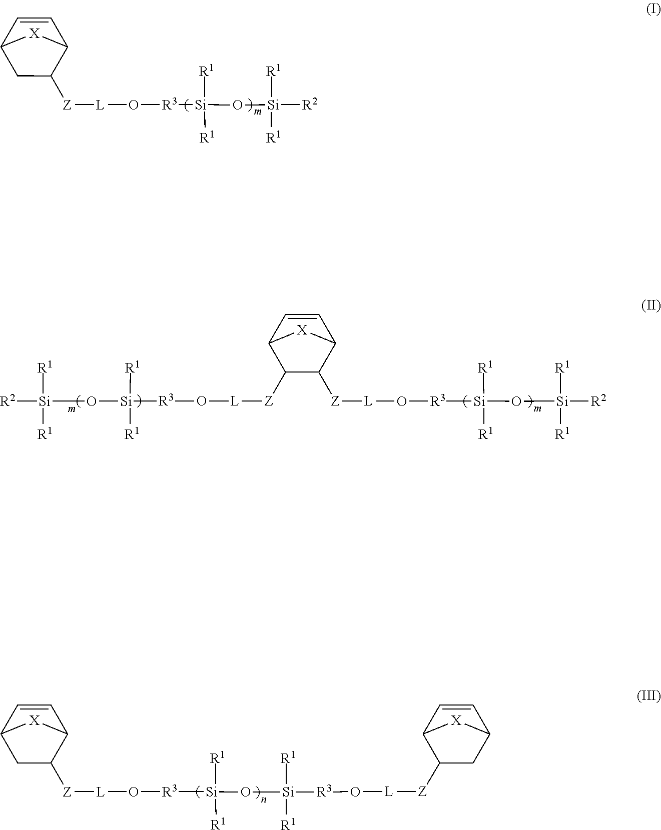

wherein in the foregoing Formulas, X is independently at each occurrence —CH₂— or —O—; R¹ is independently at each occurrence a C₁₋₆ alkyl group; R² is independently at each occurrence a C₁₋₆ alkyl group; R³ is independently at each occurrence a divalent C₁₋₁₂ alkylene group; L is independently at each occurrence a divalent C₁₋₁₂ alkylene group; Z is a single bond, an ester group, an amide group, or oxygen; m is an integer from 5 to 100; and n is an integer from 5 to 500, provided that n≥m; and wherein a degree of polymerization between crosslinks of the bottlebrush polymer network is less than two times a degree of polymerization of a primary backbone of the bottlebrush polymer network.

Aspect 2: The bottlebrush polymer network of aspect 1, wherein the bottlebrush polymer network is prepared using a molar ratio of (Formula (I)+Formula (II)):Formula (III) of 1000:1 or less.

Aspect 3: The bottlebrush polymer network of aspect 1 or 2, wherein the degree of polymerization between crosslinks of the bottlebrush polymer network is at least 350, or at least 400, or at least 450, or at least 500, or 450 to 1050.

Aspect 4: The bottlebrush polymer network of any of aspects 1 to 3, wherein the degree of polymerization of a primary backbone of the bottlebrush polymer network is at least 350, or at least 400, or at least 450, or at least 500, or 450 to 1050.

Aspect 5: The bottlebrush polymer network of any of aspects 1 to 4, wherein each occurrence of X is —CH₂—.

Aspect 6: The bottlebrush polymer network of any of aspect 1 to 5, wherein each occurrence of R¹ is methyl.

Aspect 7: The bottlebrush polymer network of any of aspects 1 to 6, wherein each occurrence of R² is butyl.

Aspect 8: The bottlebrush polymer network of any of aspects 1 to 5, wherein each occurrence of R³ is propylene.

Aspect 9: The bottlebrush polymer network of any of aspects 1 to 5, wherein each occurrence of L is ethylene.

Aspect 10: The bottlebrush polymer network of any of aspects 1 to 9, wherein m is 10 to 20.

Aspect 11: The bottlebrush polymer network of any of aspects 1 to 10, wherein n is 100 to 150.

Aspect 12: The bottlebrush polymer network of any of aspects 1 to 11, wherein the bottlebrush polymer network exhibits one or more of: a Tan(δ) of greater than 0.5 over a frequency range of 0.1 to 100 Hz, determined using dynamic mechanical analysis; a storage modulus of greater than 1 kPa at a frequency of 1 Hz or more, determined using dynamic mechanical analysis; a loss modulus of greater than 1 kPa at a frequency of 1 Hz or more, determined using dynamic mechanical analysis; a critical energy release rate of greater than 10 J/m², and a strain hardening onset between 50 and 75% of maximum elongation.

Aspect 13: The bottlebrush polymer network of aspect 1, wherein each occurrence of X is —CH₂—; each occurrence of R¹ is methyl; each occurrence of R² is butyl; each occurrence of R³ is propylene; each occurrence of L is ethylene; m is 10 to 20; n is 100 to 150; the degree of polymerization between crosslinks of the bottlebrush polymer network is at least 350, or at least 400, or at least 450, or at least 500, or 450 to 1050; and the degree of polymerization of a primary backbone of the bottlebrush polymer network is at least 350, or at least 400, or at least 450, or at least 500, or 450 to 1050; wherein the bottlebrush polymer network exhibits: a Tan(δ) of greater than 0.5 over a frequency range of 0.1 to 100 Hz, determined using dynamic mechanical analysis; a storage modulus of greater than 1 kPa at a frequency of 1 Hz or more, determined using dynamic mechanical analysis; a loss modulus of greater than 1 kPa at a frequency of 1 Hz or more, determined using dynamic mechanical analysis; and a critical energy release rate of greater than 10 J/m².

Aspect 14: A method for the manufacture of the bottlebrush polymer network of any of aspects 1 to 13, the method comprising: polymerizing a reaction mixture comprising a macromonomer according to Formula (I), Formula (II), or a combination thereof, and a macromonomer according to Formula (III)

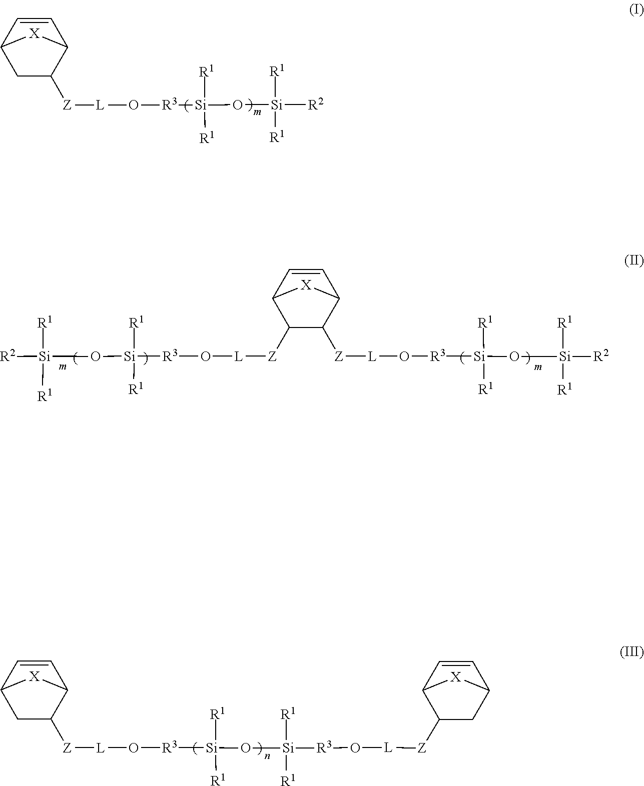

in the presence of an olefin metathesis polymerization catalyst to provide the bottlebrush polymer network; wherein in the foregoing Formulas, X is independently at each occurrence —CH₂— or —O—; R¹ is independently at each occurrence a C₁₋₆ alkyl group; R² is independently at each occurrence a C₁₋₆ alkyl group; R³ is independently at each occurrence a divalent C₁₋₁₂ alkylene group; L is independently at each occurrence a divalent C₁₋₁₂ alkylene group; Z is a single bond, an ester group, an amide group, or oxygen; m is an integer from 5 to 100; and n is an integer from 5 to 500, provided that n≥m.

Aspect 15: The method of aspect 14, wherein the polymerizing is for a time of 5 minutes to 24 hours at a temperature of 15 to 30° C.

Aspect 16: The method of aspect 14 or 15, wherein a molar ratio of (Formula (I)+Formula (II)):Formula (III) in the reaction mixture is 1000:1 or less.

Aspect 17: A pressure sensitive adhesive layer comprising the bottlebrush polymer network of any of aspects 1 to 13.

Aspect 18: The pressure sensitive adhesive layer of aspect 17, wherein additives are excluded from the pressure sensitive adhesive layer.

Aspect 19: The pressure sensitive adhesive layer of aspects 17 or 18, wherein no polymers other than the bottlebrush polymer network are present in the layer.

Aspect 20: The pressure sensitive adhesive layer of any of aspects 17 to 19, wherein the pressure sensitive adhesive layer is capable of adhering to a substrate in the presence of an aqueous solvent, at a reduced pressure, at a temperature of up to 120° C., or a combination thereof.

Aspect 21: An article comprising the pressure sensitive adhesive layer of any of aspects 17 to 20.

Aspect 22: The article of aspect 21, wherein the pressure sensitive adhesive layer is in contact with at least a portion of a first substrate.

Aspect 23: The article of aspect 22, wherein the pressure sensitive adhesive layer is further in contact with at least a portion of a second substrate on a side opposite the first substrate.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Of” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A bottlebrush polymer network, wherein the bottlebrush polymer network is prepared by ring opening metathesis copolymerization of macromonomers according to Formula (I), Formula (II), or a combination thereof and a macromonomer according to Formula (III) 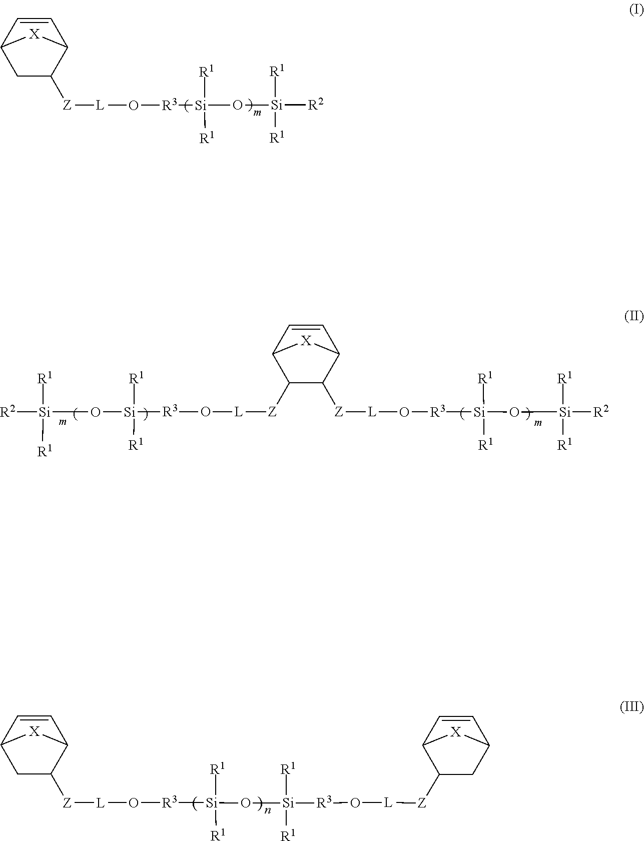
wherein in the foregoing Formulas,
X is independently at each occurrence —CH₂— or —O—;
R¹ is independently at each occurrence a C₁₋₆ alkyl group;
R² is independently at each occurrence a C₁₋₆ alkyl group;
R³ is independently at each occurrence a divalent C₁₋₁₂ alkylene group;
L is independently at each occurrence a divalent C₁₋₁₂ alkylene group;
Z is independently at each occurrence a single bond, an ester group, an amide group, or oxygen;
m is an integer from 5 to 100; and
n is an integer from 5 to 500, provided that n≥m; and
wherein
a degree of polymerization between crosslinks of the bottlebrush polymer network is less than two times a degree of polymerization of a primary backbone of the bottlebrush polymer network.

2. The bottlebrush polymer network of claim 1, wherein the bottlebrush polymer network is prepared using a molar ratio of (Formula (I)+Formula (II)):Formula (III) of 1000:1 or less.

3. The bottlebrush polymer network of claim 1, wherein the degree of polymerization between crosslinks of the bottlebrush polymer network is at least 350.

4. The bottlebrush polymer network of claim 1, wherein the degree of polymerization of a primary backbone of the bottlebrush polymer network is at least 350.

5. The bottlebrush polymer network of claim 1, wherein each occurrence of X is —CH₂—.

6. The bottlebrush polymer network of claim 1, wherein each occurrence of R¹ is methyl.

7. The bottlebrush polymer network of claim 1, wherein each occurrence of R² is butyl.

8. The bottlebrush polymer network of claim 1, wherein each occurrence of R³ is propylene.

9. The bottlebrush polymer network of claim 1, wherein each occurrence of L is ethylene.

10. The bottlebrush polymer network of claim 1, wherein m is 10 to 20.

11. The bottlebrush polymer network of claim 1, wherein n is 100 to 150.

12. The bottlebrush polymer network of claim 1, wherein the bottlebrush polymer network exhibits:
a Tan(δ) of greater than 0.5 over a frequency range of 0.1 to 100 Hz, determined using dynamic mechanical analysis;
a storage modulus of greater than 1 kPa at a frequency of 1 Hz or more, determined using dynamic mechanical analysis;
a loss modulus of greater than 1 kPa at a frequency of 1 Hz or more, determined using dynamic mechanical analysis;
an elongation at break over 100%; and
a critical energy release rate of greater than 10 J/m².

13. The bottlebrush polymer network of claim 1, wherein
each occurrence of X is —CH₂—;
each occurrence of R¹ is methyl;
each occurrence of R² is butyl;
each occurrence of R³ is propylene;
each occurrence of L is ethylene;
each occurrence of Z is an ester group;
m is 10 to 20;
n is 100 to 150;
the degree of polymerization between crosslinks of the bottlebrush polymer network is at least 350; and
the degree of polymerization of a primary backbone of the bottlebrush polymer network is at least 350;
wherein the bottlebrush polymer network exhibits:
a Tan(δ) of greater than 0.5 over a frequency range of 0.1 to 100 Hz, determined using dynamic mechanical analysis;
a storage modulus of greater than 1 kPa at a frequency of 1 Hz or more, determined using dynamic mechanical analysis;
a loss modulus of greater than 1 kPa at a frequency of 1 Hz or more, determined using dynamic mechanical analysis;
an elongation at break over 100%; and
a critical energy release rate of greater than 10 J/m².

14. A method for the manufacture of the bottlebrush polymer network of claim 1, the method comprising:
polymerizing a reaction mixture comprising a macromonomer according to Formula (I), Formula (II), or a combination thereof, and a macromonomer according to Formula (III) 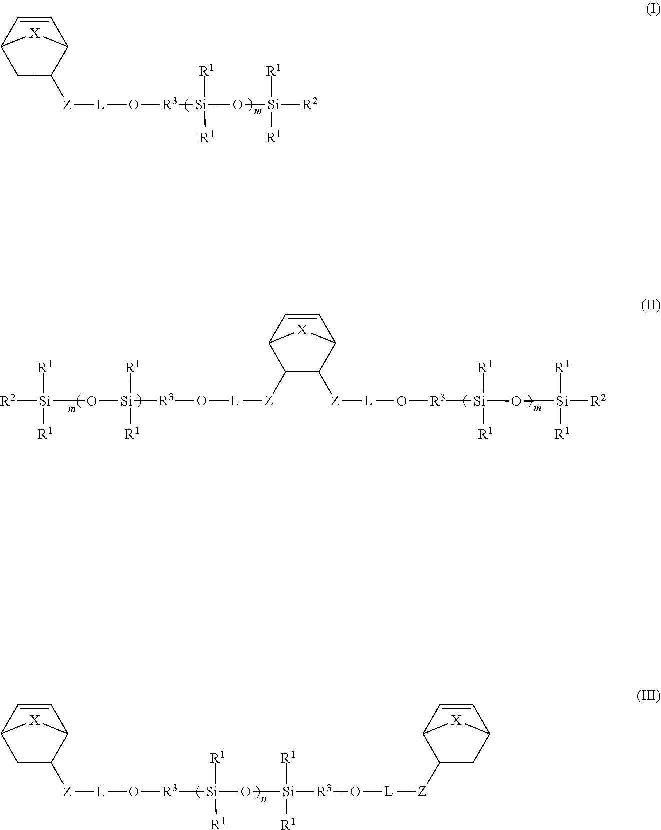
in the presence of an olefin metathesis polymerization catalyst to provide the bottlebrush polymer network;
wherein in the foregoing Formulas,
X is independently at each occurrence —CH₂— or —O—;
R¹ is independently at each occurrence a C₁₋₆ alkyl group;
R² is independently at each occurrence a C₁₋₆ alkyl group;
R³ is independently at each occurrence a divalent C₁₋₁₂ alkylene group;
L is independently at each occurrence a divalent C₁₋₁₂ alkylene group;
Z is independently at each occurrence a single bond, an ester group, an amide group, or oxygen;
m is an integer from 5 to 100; and
n is an integer from 5 to 500, provided that n≥m.

15. The method of claim 14, wherein a molar ratio of (Formula (I)+Formula (II)):Formula (III) in the reaction mixture is 1000:1 or less.

16. A pressure sensitive adhesive layer comprising the bottlebrush polymer network of claim 1.

17. The pressure sensitive adhesive layer of claim 16,
wherein additives are excluded from the pressure sensitive adhesive layer; or
wherein no polymers other than the bottlebrush polymer network are present in the layer; or
wherein additives are excluded from the pressure sensitive adhesive layer and no polymers other than the bottlebrush polymer network are present in the layer.

18. The pressure sensitive adhesive layer of claim 16, wherein the pressure sensitive adhesive layer is capable of adhering to a substrate in the presence of an aqueous solvent, at a reduced pressure, at a temperature of up to 120° C., or a combination thereof.

19. An article comprising the pressure sensitive adhesive layer of claim 16.

20. The article of claim 19, wherein the pressure sensitive adhesive layer is in contact with at least a portion of a first substrate, and optionally wherein the pressure sensitive adhesive layer is further in contact with at least a portion of a second substrate on a side opposite the first substrate.
